(19) United States
(12) Patent Application Publication
(10) Pub. No.: US 2026/0200769 A1
(43) Pub. Date: Jul. 16, 2026

(54) METHODS FOR TREATING WATER BY STABILIZING A BIOCIDE

(71) Applicant: CHEMTREAT, INC., Glen Allen, VA (US)

(72) Inventors: Benjamin NIEMASECK, Chesterfield, VA (US); Douglas MCILWAINE, Ashland, VA (US); Alexsandra CORRIGAN, Richmond, VA (US); Jack BLAND, King William, VA (US)

(73) Assignee: CHEMTREAT, INC., Glen Allen, VA (US)

(21) Appl. No.: 19/441,083

(22) Filed: Jan. 6, 2026

Related U.S. Application Data
(60) Provisional application No. 63/743,781, filed on Jan. 10, 2025.
(60) Provisional application No. 63/853,902, filed on Jul. 30, 2025.

(51) Int. Cl. C02F 1/50; C02F 103/32

(52) U.S. Cl. CPC C02F 1/50; C02F 2103/327; C02F 2303/20; C02F 2305/04

(57) ABSTRACT

Methods for treating a water system include providing a liquid treatment composition to water within the water system, the liquid treatment composition includes a stabilizer compound, a surfactant and a chlorine containing biocide, and the liquid treatment composition is substantially free of any bromine containing biocide. At one or more points during the treatment, the water of the water system may have a pH of 7.5 or greater. The stabilizer compound may be fed as a separate component into the water of the water system. The water system may be within a pasteurizer or retort cooker.

### BACKGROUND

The present invention relates to novel methods of treating water in water systems with chlorine containing biocides using stabilizing compounds that increase the efficacy of the biocide in the water systems.

Biofouling or biological fouling is the accumulation of microorganisms, plants, algae, or small animals where it is not wanted on surfaces such as surfaces and pipework that cause degradation to the primary purpose of that item. A biofilm is a thick layer of prokaryotic organisms (multiple nuclei within a single cell membrane) that have aggregated to form a colony. The colony attaches to a surface with a slime layer which aids in protecting the microorganisms.

Biofouling is a particularly detrimental type of fouling experienced in industrial water treatment applications. Regardless of industry, water treatment experts spend a considerable amount of their time focused on preventing biofouling of heat exchangers, cooling towers, etc., Pasteurizers and retort cookers are another area where biofouling can be a problem in terms of maintaining sanitary processes. When biofouled, the equipment suffers significantly in performance and requires extensive cleaning and downtime to address the issues, leading to millions of dollars in lost revenues.

The use of oxidizing and non-oxidizing biocides for microbiological control in industrial applications is known. However, the known chemistries have significant drawbacks when it comes to overall efficacy, safety, and delivery. Methods for combining stabilizers with oxidizing biocides vary, but include: (i) direct injection of the stabilizer into a biocide such as hypochlorite, which is then injected into an aqueous system, (ii) injection of the stabilizing component and biocide such as hypochlorite into the aqueous system separately but in close proximity, and (iii) creating a solid form of a stabilized product, which is then dissolved into an aqueous system.

Whether stabilized or not, oxidizing biocides have difficulty penetrating biofilms once they have been established. While it is possible to feed an exorbitant amount of oxidizing biocide to essentially “burn” the system, the high levels of free oxidant increase corrosion rates throughout the water system. To help improve the oxidizing biocide's ability to penetrate these films and make contact with the microorganisms, biosurfactants have been implemented.

Biosurfactants, sometimes referred to as biodispersants, significantly improve the efficacy of both oxidizing and non-oxidizing biocides. There are subtle differences between biosurfactants and biodispersants, but they have the same function-minimize the growth and adherence of biofilms. Biosurfactants work by actually removing the biofilm in a scrubbing type action, while biodispersants disperse biomatter so that it cannot agglomerate. Research has shown that biofilms are typically 30 to 40% organic matter, with the rest being inorganic material such as silt, metals, and other particulate matter. Other dispersants, such as sulfonated polymers and copolymers, are sometimes used in conjunction with biodispersants and biosurfactants to help disperse these inorganic materials. While this approach can be effective, it involves a comprehensive and cumbersome water chemistry program.

With respect to the use of biocides in water systems, particular difficulty has been encountered when the pH of the water within the water system increases above 7.5 pH, such as 8.5 pH and higher. As the pH of water in a water system increases above about 7.5, bromine-based compounds and chemistries (hereinafter collectively referred to as bromine-based compounds) have been used as the biocides of choice instead of chlorine-based compounds. This has been because most biocidal species of the chlorine-based compounds are hypochlorous compounds, which at higher pH converts mostly to the significantly less biocidal hypochlorite. Hypobromous compounds, however, are typically highly antimicrobial and predominate up through pH of about 8.8. This allows for significantly better efficacy in higher pH systems, and thus bromine-based compounds have become the norm as biocides in higher pH water systems to limit corrosion potential.

Using bromine-based biocides has significant downsides, though, which include having to have two registered biocides onsite because forming hypobromous acid requires a reaction of bleach (e.g., sodium hypochlorite) with sodium bromide and needing a significantly more expensive stabilized bromine product.

There is also a growing push to remove bromine from plant effluent waters for environmental and safety reasons.

U.S. Pat. No. 10,701,930, which is hereby incorporated by reference in its entirety, is directed to a method for stabilizing an oxidizing biocide, in which an unhalogenated hydantoin is mixed with a surfactant and water to form a liquid treatment composition that is subsequently mixed with calcium hypochlorite, chlorine gas, and/or sodium hypochlorite and then added to a water system in order to improve the efficacy of the oxidizing biocide in a water system. However, it was still believed that this method would not be effective within higher pH systems, and thus bromine-based biocide compounds have still been applied within higher pH systems.

What is desired is a method for treating water in a water system for biofouling in which bromine-based compounds are not used, and chlorine-based biocides are able to exhibit increased efficacy.

### SUMMARY

The present application relates to a method for treating a water system, the method comprising providing a liquid treatment composition to water within the water system, wherein at one or more points during the treatment, the water of the water system has a pH of 7.5 or greater, wherein the liquid treatment composition comprises a stabilizer compound, a surfactant and a chlorine containing biocide, and wherein the liquid treatment composition is substantially free of any bromine containing biocide.

It has been found that the combined use of the chlorine containing biocide with the stabilizer compound and the surfactant permits the chlorine containing biocide to retain efficacy at higher pHs of 7.5 or more, including pHs of 8.5 or more.

The water system may be within a pasteurizer device or retort cooker device.

The present application also relates to a method for treating a water system for biofouling, the method comprising providing a stabilizer compound for a chlorine species to water within the water system, wherein the providing is selected from the group consisting of:
(a) where the water of the water system contains a chlorine species, providing the stabilizer compound to the water of the water system in a feed composition consisting of the stabilizer compound, optionally water and optionally a surfactant;
(b) providing the stabilizer compound to the water of the water system in a feed composition consisting of the stabilizer compound, a chlorine containing biocide and optional water, and separately providing a surfactant to the water of the water system; and
(c) providing the stabilizer compound to the water of the water system in a feed composition consisting of the stabilizer compound, a surfactant and optionally water, and separately providing a chlorine containing biocide to the water of the water system.

It has also been found that where there is one or more chlorine species in the water of the water system, addition of the chlorine stabilizer alone in a separate feed into the water of the water system can be sufficient to effectively combat biofouling.

### BRIEF DESCRIPTION OF THE DRAWING

FIG. 1 is a generalized schematic of a pasteurizer having a water system with which the methods of the present application may be applied.

FIG. 2 is a chart summarizing the monitoring of biofilm levels in a pasteurizer.

### DETAILED DESCRIPTION OF EMBODIMENTS

Although specific embodiments are described herein, the scope of the invention and claims is not limited to only those specific embodiments. The scope of the invention is defined by the following claims and any equivalents therein. As will be appreciated by one skilled in the art, aspects of the present disclosure may be embodied as an apparatus, system or method.

The terms “comprise(s),” “comprising,” “include(s),” “including,” “having,” “has,” “contain(s),” “containing,” and variants thereof, as used herein, are open-ended transitional phrases, terms, or words that are meant to encompass the items listed thereafter and equivalents thereof as well as additional non-recited items. The singular forms “a”, “and”, and “the” include plural references unless the context clearly dictates otherwise. Where the term “comprising” is used, the present disclosure also contemplates other embodiments “comprising”, “consisting of”, or “consisting essentially of” elements presented herein, whether explicitly set forth or not. “Consisting of” is intended as a close-ended transitional term excluding non-recited components or optional components.

Any numerical range recited herein includes all values from the lower value to the upper value. For example, if a concentration range is stated as 1% to 50%, it is intended that values such as 2% to 40%, 10% to 30%, or 1% to 3%, etc., are expressly enumerated in this specification. These are only examples of what is specifically intended, and all possible combinations of numerical values between and including the lowest value and the highest value enumerated are to be considered to be expressly stated in this application.

The modifier “about” used in connection with a quantity is inclusive of the stated value and has the meaning dictated by the context (for example, it includes at least the degree of error associated with the measurement of the particular quantity). The modifier “about” should also be considered as disclosing the range defined by the absolute values of the two endpoints. For example, the expression “from about 2 to about 4” also discloses the range “from 2 to 4.” The term “about” may refer to plus or minus 10% of the indicated number. For example, “about 10%” may indicate a range of 9% to 11%, and “about 1” may mean from 0.9-1.1. Other meanings of “about” may be apparent from the context, such as rounding off, so, for example “about 1” may also mean from 0.5 to 1.4.

In general, the amount of a component in a composition as disclosed herein is expressed “by weight” which refers to the percentage of the component's weight in the total weight of the composition. Unless indicated otherwise, all concentrations are expressed as weight percentage concentrations.

“Substantially free of” herein means no more than immeasurable trace or impurity amounts, and as one example may mean less than about 0.01% by weight.

In the methods of treating water in a water system, for example in order to treat, mitigate and/or prevent biofouling within the water system, an oxidizing biocide is introduced into the water of the water system. A preferred method of introducing the oxidizing biocide into the water of the water system is by injection, for example through a port or opening having access to the water within the water system. The adding to the water system may be via a continuous drip feed or slug feed process.

The water system may include, but is not limited to, cooling water systems, cooling towers, surface condensers, scrubbers, heat exchangers, air washers, evaporative condensers, once-through cooling water systems, paper mill water systems, reverse osmosis system feedwaters, retort cookers and pasteurizers such as brewery pasteurizers.

In a first embodiment, the efficacy of a chlorine containing biocide is increased with respect to use in water having a pH of 7.5 or more, such as a pH of 8 or more or a pH of 8.5 or more. In this embodiment, the pH of the water is not necessarily, but may be, constantly 7.5 or higher. Where the pH of the water is at one or more points during the treatment with a liquid treatment composition at a pH of 7.5 or more, the liquid treatment composition is able to retain its effectiveness. Thus, in this embodiment, the chlorine containing biocide is included in a liquid treatment composition that is able to stabilize the chlorine species so as to remain effective in the higher pH environment.

The liquid treatment composition includes at least a stabilizer compound, a surfactant and the chlorine containing biocide, and the liquid treatment composition is substantially free of any bromine containing biocide.

The use of the stabilizer compound stabilizes the chlorine containing compound by combining or reacting therewith to form a stabilized chlorine product that is available to combat biofouling even at the higher pHs. The reaction converts a portion or all of the free chlorine species into a combined chlorine species, which is more stable and less reactive. As a result, the amount of free residual chlorine in the system is reduced. Here, total chlorine consists of the free chlorine species and chloramine species that can include monochloramine, dichloramine, trichloramine, the chlorinated hydantoin or other species that are formed as the result of the reaction of hypochlorous acid and a nitrogen containing compound. Because the chlorine has combined or reacted with a nitrogen containing compound, it is referred to as a combined species. An effect of the combined species is to reduce the reactivity of the chlorine containing compound, which allows the compound to have a longer half life and retain its biocidal efficacy in the higher pH environment, and reduce the tendency of the compound to react with any number of contaminants such as ammonia at the higher pH. The foregoing is applicable to other halogen containing compounds in addition to chlorine containing compounds.

The stabilizer also has the effect of creating a halogen or chlorine “reservoir” in the water system, and converts a portion of free residual chlorine to a stable chlorine. The composition is thus less reactive so as to reduce oxidation of equipment (corrosion). The composition is also better able to react with and eliminate biofilm.

The usage and handling of commercial oxidizing biocides are generally governed by the Environmental Protection Agency's (EPA) Toxic Substances Control Act (TSCA). As will be understood by one of ordinary skill in the art, any suitable chlorine containing oxidizing biocide within acceptable EPA-designated concentrations are contemplated by this disclosure. For example, in embodiments, the chlorine containing biocide may be sodium hypochlorite (NaOCl) (bleach), chlorine gas (Cl₂), or calcium hypochlorite (Ca(OCl)₂). The concentration of the biocide contemplated by this disclosure is not particularly limited. For purposes of this disclosure, the biocide will be described with reference to industrial bleach or sodium hypochlorite, which may be in the range of 10% to 20% solution, and usually 12%, user-dilution notwithstanding.

In embodiments, the preferred formulation is a mixture of a bleach stabilizing compound and a surfactant that increases the efficacy of bleach as an oxidizing biocide. Given that bleach is heavily regulated as a toxic substance under EPA regulations, it is costly to handle and transport. Therefore, in embodiments, the stabilizer and surfactant are pre-mixed in a liquid composition and transported to the water system to be mixed with the bleach in situ. In this regard, the bleach may be prepared on-site of the water system, significantly reducing costs. The stabilizer/surfactant blended chemistry is non-biocidal, thereby eliminating hazards typically associated with transporting and handling conventional biocide chemistries.

According to embodiments, the preferred stabilizer is a hydantoin compound such as, for example, an unhalogenated alkyl hydantoin. An unhalogenated alkyl hydantoin is a heterocyclic organic compound, the general structure of which is illustrated below.

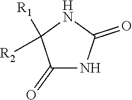

In the formula, R₁ and R₂ are the same or different and are each selected from the group consisting of H and a C₁-C₃ alkyl group, i.e., CH₃, C₂H₅, or C₃H₇. Preferably, R₁ and R² are each CH₃.

Hydantoin is a colorless solid that arises from the reaction of glycolic acid and urea. It is an oxidized derivative of imidazolidine. An unhalogenated alkyl hydantoin compound is uniquely suited to stabilize the oxidizing biocide by the formation of biocidal by-products such as chloramines through a known reaction of hydantoin with, for example, bleach. Chloramines may include, but are not limited to, monochloramine, dichloramine, and organic chloramines. Chloramines provide long-lasting protection and are more stable than pure chlorine products as they do not break down as quickly in water systems. In the absence of the stabilizer compound, the chlorine containing biocide would almost completely oxidize into chloride, particularly at a higher pH of 7.5 or more.

Industrial bleach is known to oxidize most surfactants along with target biofilms in water treatment systems. Any surfactant that exhibits stability with bleach would generally be considered suitable for use in the disclosed methods and formulations. For example, the surfactant may be, but is not limited to, any one or more of the following: linear alkylbenzene sulfonate, sodium lauryl sulfoacetate, disodium lauryl sulfosuccinate, sodium dioctyl sulfosuccinate, alkyl polyglycoside, sodium dodecylbenzene sulfonate, nonionic polyoxyethylene, polyoxypropylene block copolymer, ethoxylated alkyl phenol nonionic surfactant, glucoside, terpene-based proprietary dispersant, ethylene oxide/propylene oxide alcohols, polyoxyethylene ether, sodium dodecyl diphenyloxide disulfonate and mixtures thereof. Preferably, the surfactant is an alkyl polyglycoside or ethylene oxide/propylene oxide alcohols, which exhibit particularly unexpected stability in the presence of industrial bleach and other chlorine containing biocides.

The surfactant is able to remove and disperse the biofilm and other organic materials.

A ratio of concentration of the stabilizer to the surfactant in the liquid treatment composition may be in a range of, for example, 1:1 to 99:1 by volume, preferably 9:1 to 99:1 by volume, and more preferably 19:1 to 99:1 by volume.

An optional halide ion source may also be added to the stabilizer/surfactant liquid composition. The optional halide ion source may include, but is not limited to, sodium iodide, calcium iodide, and potassium iodide and mixtures thereof, and preferably does not include any bromides. In disclosed embodiments, a ratio of concentration of the halide ion source to the stabilizer in the liquid treatment composition is in a range of 0.001:1 to 20:1, preferably 0.1:1 to 10:1, and more preferably 0.05:1 to 4:1 by volume.

According to embodiments, a method for forming the liquid treatment composition may include mixing the stabilizer and the surfactant, optionally with water, to form a base liquid composition according to the formulations described above. Then, this base liquid composition can be mixed with the chlorine containing biocide to form the liquid treatment composition, and the liquid treatment composition is added to the water of the water system, such that the liquid treatment composition improves the efficacy of the biocide in the water stream of the water system.

In embodiments, mixing the base liquid composition with the biocide may include mixing the base liquid composition with the biocide in situ to form the liquid treatment composition. Mixing the base liquid composition with the biocide may also include mixing the base liquid composition with the biocide separately into a carry water solution to form the liquid treatment composition.

The mixing or blending of the stabilizer/surfactant base liquid composition and the biocide may be accomplished by direct injection of the biocide into the base liquid composition. This blending may be done by in-line feeding or direct injection of the biocide and the base liquid composition separately into carry-water. This method of applying the unique stabilizer/surfactant liquid chemistry with the bleach in situ provides a safe and effective means of delivering an effective biocide program without the use of expensive, complicated generating systems.

A suitable ratio of the concentration of the chlorine containing biocide bleach to the stabilizer in solution at the point of application may be in a range of, for example, 0.2:1 to 8:1 by volume, preferably 1:1 to 5:1 by volume, and more preferably 1:1 to 3:1 by volume.

The liquid treatment composition including the stabilizer/surfactant base liquid composition and the chlorine containing biocide compound may be added to the water of the water treatment system in the feed line or carry-water at a concentration in a range of, for example, 0.05 mg/L to 1,000 mg/L or 0.1 to 300 mg/L, preferably 1 to 10 mg/L, and more preferably 0.5 to 5 mg/L, relative to all components in the water stream of the water system.

In a second embodiment of the methods described herein, it has also been surprisingly found that separate addition of the stabilizer compound itself into a water system where chlorine species are present can also be effective in combating biofouling within the water system.

In this method, the stabilizer compound can be fed by itself, optionally diluted or mixed with water, into the water of the water system, particularly where the water of the water system contains chlorine species, for example as residual from prior addition of a chlorine containing biocide into the water system. A surfactant may also be separately fed in this aspect of the method. Alternatively, the stabilizer compound may be fed together with the surfactant in a previously formed mixture, as in the base liquid composition described above.

Still further, the stabilizer compound can be fed either in line with the neat chlorine chemistry or into a line of dilute chlorine chemistry, i.e., the chlorine containing biocide diluted with water.

Thus, in this embodiment, the method comprises providing a stabilizer compound to water within the water system. The providing may include providing the stabilizer compound for a chlorine species to the water of the water system in a feed consisting of the chlorine stabilizer compound, and optionally water and optionally a surfactant, where the water of the water system includes a chlorine species. If the chlorine stabilizer compound is fed without a surfactant, the surfactant is preferably separately fed into the water of the water system, and preferably at an introduction point in reasonably close proximity to the introduction point of the stabilizer compound. Of course, chlorine containing biocide may also be added separately into the water system as needed.

The providing may also include providing the stabilizer compound to the water of the water system in a feed consisting of the stabilizer compound mixed with the chlorine containing biocide and optionally water and separately providing the surfactant to the water of the water system. Still further, the providing may also include providing the stabilizer compound to the water of the water system in a feed consisting of the stabilizer compound mixed with the surfactant and optionally water and separately providing the chlorine containing biocide to the water of the water system. Where separate feeds are introduced into the water system, the separate feeds preferably have an introduction point in reasonably close proximity to each other within the water system.

It has also been found that where there is one or more chlorine species in the water of the water system, addition of the chlorine stabilizer alone in a separate feed into the water of the water system can be sufficient to effectively combat biofouling by increasing the efficacy of the chlorine species within the water system.

In this embodiment of the methods, the concentrations and amounts of the materials introduced into the water system may be the same as detailed above for the liquid treatment composition.

In a particular embodiment, the water system is within an industrial device such as a pasteurizer device or retort cooker device, for example as used in the food and beverage industry for food safety. A pasteurizer device is discussed below for illustration, but the below-discussed aspects apply similarly to any industrial device, including a retort cooker.

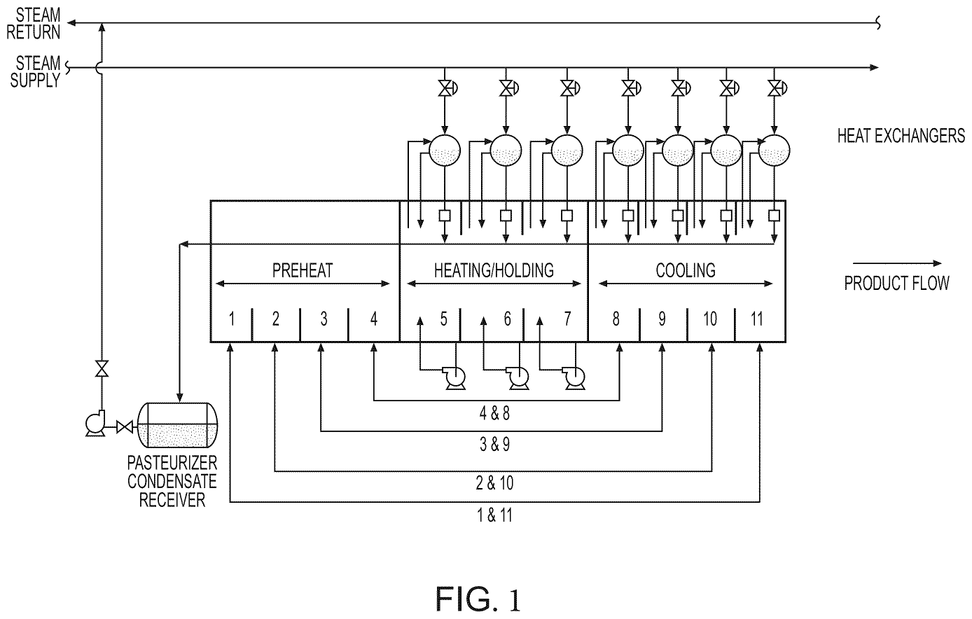

The water system in a pasteurizer, for example, typically includes a preheat section (zones 1-4 in FIG. 1), a heating/pasteurization section (zones 5-7 in FIG. 1) and a cooling section (zones 8-11 in FIG. 1). A product, such as cans, bottles or the like, containing a food or beverage is fed through the pasteurizer, for example on a conveyor belt made of a material such as polypropylene. The water system supplies water throughout the pasteurizer to effect the function of each of the sections.

The pasteurizer may optionally include regeneration zones, each comprised of coupled zones from the preheat section and from the cooling section. Regeneration zones are not required but are shown as present in FIG. 1 for illustration purposes. Further, the pasteurizer may include regeneration zones that may be idled or bypassed for a given product treatment. In FIG. 1, zones 1 and 11, zones 2 and 10, zones 3 and 9 and zones 4 and 8, are each a regeneration zone. Each regeneration zone is coupled via piping, and work to conserve energy by alternating heating and cooling the water as it flows through each regeneration zone. For example, hotter water loses heat as it heats up the incoming product in a zone of the preheat section, the hotter water thus transitioning to a cooler water that is pumped to the coupled cooling section zone where the cooler water is used to cool the hot product entering the cooling zone. The cooler water, after it has been heated in the cooling section to transition to hotter water, is then again fed back to the coupled zone in the preheat section. If necessary, the temperature of the water may be raised to a higher temperature for use in the preheat and heating sections using, e.g., a heat exchanger such as a steam/water heat exchanger.

To control and/or prevent biofilm growth (biofouling) on surfaces in the water system and pasteurizer, the above-detailed methods for treating a water system are used. In this regard, the stabilizer compound, the chlorine containing biocide and the surfactant liquid composition are fed into the water system, preferably into the regeneration zones, as needed, which may be only intermittent feeding of each component separately or together at determined intervals or may be a continuous feeding of each component separately or together into the water system. In a preferred pasteurizer system, a chlorine containing biocide such as bleach is maintained in the water system at all times, and the stabilizer compound and the surfactant are fed, together or separately, at intervals into the water system, such as 1 to 50 times per day.

As evident from the foregoing, the method herein permits the water system of the pasteurizer or retort cooker to be treated for biofilm while the water system is in use in performing the intended treatment of the products few through the pasteurizer or retort cooker.

It has been found that introduction of the liquid treatment composition into the water system permits the use of lower amounts of chlorine containing biocide, which not only saves money, but also significantly reduces corrosion rates within the pasteurizer or retort cooker as well as significantly reducing degradation of the belt, in particular a polyolefin-based belt such as a polypropylene belt, used to carry product through the device. These types of belts tend to degrade more rapidly upon constant exposure to high amounts of free residual chlorine species.

In addition, it has also been surprisingly found that in food or beverage can pasteurizers or retort cookers, where the can is made using a conventional necker lubricant such as a food-grade mineral oil or wax, use of the liquid composition in the water system of the device also effectively removes the remnant necker lube from the pasteurizer. This saves tremendous time in avoiding downtime for cleaning that is otherwise required when necker lubricant builds up within the device.

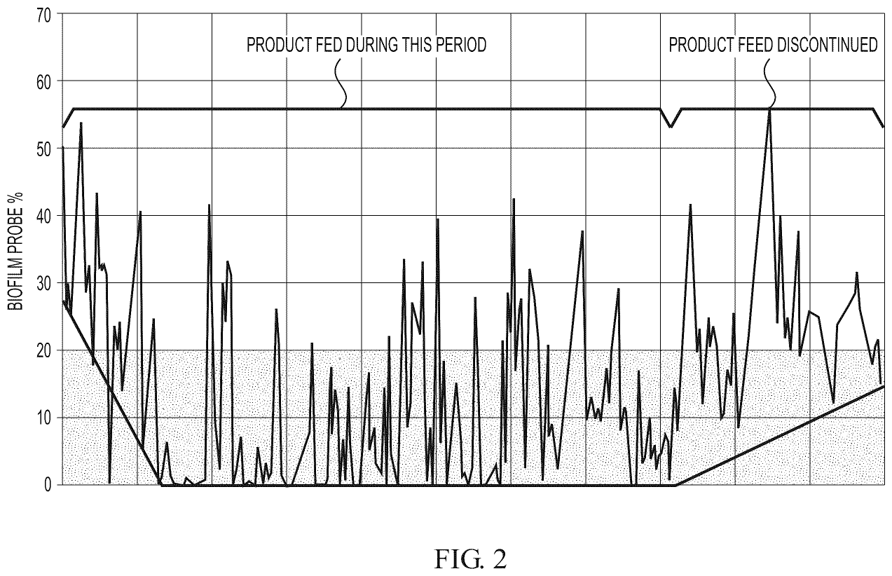

In an experimental study, a pasteurizer historically treated with liquid NaOCl bleach/NaBr (20:1 feed ratio by volume) was treated periodically each day with the addition of the treatment composition of the present application in amounts of 4 oz (118 ml) to the preheat zone and 8 oz (236 ml) to the cooling zone, with a total of 36 oz (1,064 ml) of the treatment composition added per day to the pasteurizer. The addition of the treatment composition reduced the free residual chlorine from about 4.3 ppm on average to about 0.57 ppm on average, significantly reducing the corrosion of the equipment and lengthening the life of the polypropylene belt. The amount of biofilm present was also reduced, on average, as shown in FIG. 2, where biofilm levels were monitored with a probe both during and after discontinuation of administration of the treatment composition.

It will be appreciated that the above-disclosed features and functions, or alternatives thereof, may be desirably combined into different systems or methods. Also, various alternatives, modifications, variations or improvements may be subsequently made by those skilled in the art. As such, various changes may be made without departing from the spirit and scope of this disclosure.

What is claimed is:

1. A method for treating a water system, the method comprising:
providing a liquid treatment composition to water within the water system,
wherein at one or more points during the treatment, the water of the water system has a pH of 7.5 or greater,
wherein the liquid treatment composition comprises a stabilizer compound, a surfactant and a chlorine containing biocide, and
wherein the liquid treatment composition is substantially free of any bromine containing biocide.

2. The method according to claim 1, wherein the chlorine containing biocide is selected from the group consisting of sodium hypochlorite, hypochlorous acid, chlorine gas (Cl₂), calcium hypochlorite, and combinations thereof.

3. The method according to claim 1, wherein at one or more points during the treatment, the water of the water system has a pH of 8.5 or greater.

4. The method according to claim 1, wherein the stabilizer compound is a hydantoin.

5. The method according to claim 4, wherein the hydantoin is an unhalogenated alkyl hydantoin of the formula: 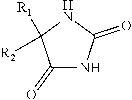
wherein R¹ and R₂ are the same or different and are each selected from the group consisting of H and a C1-C3 alkyl group.

6. The method according to claim 5, wherein in the hydantoin, R₁ and R₂ are each CH₃.

7. The method according to claim 1, wherein a ratio of a concentration of the chlorine containing biocide to the stabilizer compound in the liquid treatment composition is in a range of 1:1 to 3:1 by volume.

8. The method according to claim 1, wherein the liquid treatment composition is provided as a formed mixture of the stabilizer compound, the surfactant, the chlorine containing biocide and water.

9. The method according to claim 1, wherein the liquid treatment composition is provided by injecting the liquid treatment composition into the water of the water system.

10. The method according to claim 1, wherein the liquid treatment composition is added to the water of the water system at a concentration in a range of 0.1 mg/L to 300 mg/L.

11. The method according to claim 1, wherein the water system is within a pasteurizer or retort cooker.

12. The method according to claim 1, wherein the water system is within a pasteurizer, and the liquid treatment composition is provided to the water system through introduction into one or more regeneration zones of the pasteurizer.

13. A method for treating a water system of a pasteurizer or retort cooker, wherein the water system treats products fed through the pasteurizer or retort cooker, the method comprising:
providing a liquid treatment composition to water within the water system,
wherein the liquid treatment composition comprises a stabilizer compound, a surfactant and a chlorine containing biocide, and
wherein the liquid treatment composition is substantially free of any bromine containing biocide.

14. A method for treating a water system for biofouling, the method comprising:
providing a stabilizer compound for a chlorine species to water within the water system, wherein the providing is selected from the group consisting of:
(a) where the water of the water system contains a chlorine species, providing the stabilizer compound to the water of the water system in a feed composition consisting of the stabilizer compound, optionally water and optionally a surfactant;
(b) providing the stabilizer compound to the water of the water system in a feed composition consisting of the stabilizer compound, a chlorine containing biocide and optionally water, and separately providing a surfactant to the water of the water system; and
(c) providing the stabilizer compound to the water of the water system in a feed composition consisting of the stabilizer compound, a surfactant and optionally water, and separately providing a chlorine containing biocide to the water of the water system.

15. The method according to claim 14, wherein the chlorine containing biocide is selected from the group consisting of sodium hypochlorite, hypochlorous acid, chlorine gas (Cl₂), calcium hypochlorite, and combinations thereof.

16. The method according to claim 14, wherein the stabilizer compound is a hydantoin.

17. The method according to claim 16, wherein the hydantoin is an unhalogenated alkyl hydantoin of the formula: 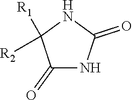
wherein R¹ and R² are the same or different and are each selected from the group consisting of H and a C₁-C₃ alkyl group.

18. The method according to claim 17, wherein in the hydantoin, R₁ and R₂ are each CH₃.

19. The method according to claim 14, wherein the water system is within a pasteurizer or retort cooker.

20. The method according to claim 14, wherein the water system is within a pasteurizer, and the liquid treatment composition is provided to the water system through introduction into one or more regeneration zone of the pasteurizer.
